(19) United States
(12) Patent Application Publication
(10) Pub. No.: US 2025/0198907 A1
(43) Pub. Date: Jun. 19, 2025

(54) SYSTEM AND METHOD FOR DETECTING CORROSION

(71) Applicants: FORCE TECHNOLOGY, Brøndy (DK); AARHUS UNIVERSITET, Aarhus (DK)

(72) Inventors: Jaamac Hassan HIRE, Brøndy (DK); Farshad MORADI, Aarhus C (DK)

(21) Appl. No.: 18/846,347

(22) PCT Filed: Mar. 10, 2023
(86) PCT No.: PCT/DK2023/050040

§ 371 Date: Sep. 12, 2024

(30) Foreign Application Priority Data
Mar. 14, 2022 (DK) PA 2022 70100

(51) Int. Cl. G01N 17/00; G01N 17/02

(52) U.S. Cl. CPC G01N 17/006; G01N 17/02

(57) ABSTRACT

System and a method for detecting corrosion or cracks in a metal structure embedded in concrete. Piezoelectric transducers are arranged for contact with the metal structure embedded in the concrete: an electronic circuit generate an electric test signal for the piezoelectric transducers and receives an electric return signal from the piezoelectric transducers. The electronic circuit comprises an analysis circuit for analysing the electric return signal and for storing the result of the analysis until the results can be communicated to an external device.

### FIELD OF THE INVENTION

The present invention relates to system and a method for detecting corrosion or cracks in a metal structure embedded in concrete.

### BACKGROUND OF THE INVENTION

Structural Health Monitoring (SHM) systems can detect hazardous damages due to corrosion or cracks. Bridges, tunnels, buildings and other critical infrastructure are often made at least partly of reinforced concrete, where there is a metal structure in the concrete to reinforce the concrete. Unfortunately, the metal may corrode or rust and the reinforced concrete therefore only has a limited lifespan.

Today's existing sensors for monitoring corrosion, which are based on traditional non-destructive evaluation (NDE) methodologies, suffer from several shortcomings for contemporary demands, such as lack of precision, low durability and high-power usage.

SHM can be regarded as an improved way of doing the NDE by utilizing novel sensor integration, smart-materials, processing and data-transmission. Using SHM in Wireless Sensor Networks (WSN) and energy-harvesting configurations, the system can be made autonomous and self-sustainable. SHM can be performed using several methodologies like wave propagation, frequency-response transfer function and Electromechanical Impedance (EMI).

EMI measurements are typically obtained using an impedance analyzer. However, the cost of an impedance analyzer is about 40.000 USD, it weights approximately kg and has a high-power consumption, which makes it infeasible to use in a small Wireless Sensor Network (WSN) system. This limits the use of large-scale EMI-based techniques such as in industrial and field applications.

The EMI method for corrosion monitoring in reinforced concrete has been investigated by researchers. Due to the high loading of the concrete on the piezoelectric transducers—it is difficult to obtain a proper signal, which means that the sensitivity is very low. The typical patch-size that is used in the EMI technique is 10×10×0.3.mm.

In order to utilize the electromechanical impedance technique in a real-world application, the electronic equipment must be miniaturized, and its cost must be reduced.

Hence, an improved system and method for detecting corrosion or cracks would be advantageous, and in particular, a cheaper, more efficient and reliable system would be advantageous.

### OBJECT OF THE INVENTION

It is an object of the present invention to provide an improved system and a method for detecting corrosion or cracks in metal structures embedded in concrete.

In particular, it may be seen as an object of the present invention to provide a system and a method for detecting corrosion or cracks that solves the above mentioned problems of the prior art with a system and a method that is low-cost, low-powered, with long durability, and which is small-sized.

Further, it may be seen as an object of the present invention that the system easily can be embedded into structures for in-situ SHM.

### SUMMARY OF THE INVENTION

Thus, the above described object and several other objects are intended to be obtained in a first aspect of the invention by providing a system for detecting corrosion or cracks in a metal structure embedded in concrete, the system comprising
at least one piezoelectric transducer arranged for contact with the metal structure,
an electronic circuit arranged for electric connection to the piezoelectric transducer, the electronic circuit comprising
a signal generator arranged to generate an electric test signal (Iₚ) to the at least one piezoelectric transducer,
an analysis circuit arranged to receive an electric return signal (I_{DUT}) from the at least one piezoelectric transducer in response to the electric test signal (Iₚ), and to electrically transform said electric return signal (I_{DUT}) from the piezoelectric transducer by means of a dual-phase lock-in amplifier circuit into a resulting electromechanical impedance or voltage representation of the metal structure, and
an interface arranged to communicate said electromechanical impedance representation or voltage representation to an external device.

The electromechanical impedance (EMI) technique is applied for measuring the electromechanical impedance or voltage representation. The electromechanical impedance (EMI) technique utilizes piezoelectric transducers, in most cases; lead zirconate titanate (PZT) patches are used. The size of the PZT patches preferable is 10×10×1.5 mm. The electromechanical interaction between the PZT patches and the host structure is the main principle to the corrosion detection in the EMI method.

Exciting a sinusoidal voltage across a square bonded PZT patch, where the length is typically much larger than the thickness, deformations are produced both in the patch and in the host structure. The deformations in the length direction is typically in the order of micrometres (μm) and in the thickness direction in the order of nanometres (nm). The imposed mechanical vibrations are transferred back to the PZT patch, and it is reflected in the form of an electrical response, as impedance (or the inverse of impedance called admittance) measurements. Any changes in the mechanical properties of the host structures, such as mass or stiffness loss will be reflected in the electrical impedance/admittance signature.

The EMI method requires a large frequency span with high resolution, but not an accurate impedance value. The method is only interested in the changes from a baseline in the EMI method. The optimized design is from the frequency area of 30-400 kHz.

The system of the present invention comprises different devises, which may be one or more piezoelectric transducers or patches, an electronic circuit for generating signals for the transducers and for receiving signals from the transducers. The electronic circuit analyses the received signals in the analysis circuit, and communicates the results to an external device. Further, there may be a frequency generator for generating the excitation signal. The frequency generator may be part of the electronic circuit, or it may be external and connected to the electronic circuit; also, a microcontroller may be either internal or external to the electronic circuit for controlling the signal generation.

Further, the system must be powered by a power source, which may be batteries also imbedded in the concrete.

At least one piezoelectric transducer is arranged for contact with the metal structure, however usually several piezoelectric transducers are applied in real measurements in large structures like bridges, tunnels or buildings.

For simplifying the description often the expression “piezoelectric transducers” will be used in the description instead of “at least one piezoelectric transducer”, when this term “piezoelectric transducers” is used, it is to be understood as there is “at least one piezoelectric transducer” and the expressions are used interchangeable.

The system of the invention may be referred to in the below description as a Lock-in analyser.

The electronic circuit is arranged for being electrical connected to the piezoelectric transducers. The piezoelectric transducers receives an electric test signal from the electronic circuit and the piezoelectric transducers returns electrical signals to the electronic circuit.

Multiple multiplexers may be used to switch the single piezoelectric transducers on and off to the electronic circuit, such that the piezoelectric transducers are activated one at a time.

The electronic circuit is comprising a signal generator, which is arranged to generate the electric test signal to the piezoelectric transducers. The test signal typically is a sine wave.

An analysis circuit is arranged to receive the electric return signals from the piezoelectric transducers. The analysis circuit is transforming the electric return signals to an electromechanical impedance representation or to a voltage representation of the metal structure.

The interface is receiving the representation of the metal structure and is storing the representation until it can communicate the stored representations to an external device. The communication may be a wireless transmission of the representations to an external device.

The external device may be a computer, a mobile phone, or any other device capable of receiving and storing data.

The invention is particularly, but not exclusively, advantageous for obtaining a low-cost and low powered system, which is small and easy to handle, for detecting corrosion and cracks in reinforced concrete. The general aim of the present invention is to go from the present day bulky and expensive laboratory-size impedance analyser to a low-cost and low-power integrated-circuit impedance analyser that can be easily embedded into structures for in-situ SHM.

According to an embodiment, the signal generator is arranged to receive an excitation signal from a frequency generator.

A digitally programmable frequency waveform generator is used; it may for instance be the commercial available AD9833 IC frequency waveform generator. The device is controlled by a microcontroller, which may be the commercial available PSoC5LP microcontroller.

According to an embodiment, the frequency generator is arranged to generate sine waves from 30-400 kHz for the excitation signal.

Generating sine waves in the 30-400 kHz range has the advantage of achieving high sensitivity for concrete damage detection by allowing the wavelength to interact with the damages in the concrete. The frequency band of 30-400 kHz is where peaks in impedance occur for corrosion detection in metal-reinforced concrete structures, as this frequency range contains the resonance frequencies. Moreover, wavelengths above 400 kHz can be influenced by the intrinsic behaviour of the piezoelectric transducer. Piezo transducers have a resonant frequency that depends on their physical dimensions and mechanical properties. If the frequency of the input signal is too far from the resonant frequencies, the transducer may not produce the desired output. Therefore, it is an advantage to limit the frequency of the input signal to the range, wherein the peaks in impedance occurs. Measurements at wavelengths below 30 kHz may be impacted by external noise such as vibrations. Therefore, it is significant to realize that generating sine waves within the 30-400 kHz range for the excitation signal (Vin) produces optimal measurements. Limiting the system to this frequency range is both sufficient and optimal.

Pure sine waves from 30-400 kHz are generated to excite the piezoelectric patches attached to the structure. Resolution down to 0.3 Hz can be obtained, but 10 Hz to 1 kHz is also utilized and is usually sufficient.

According to an embodiment, the signal generator is arranged to generate the electric test signal to the at least one piezoelectric transducer by applying the excitation signal (Vᵢₙ) via an all-pass phase filter.

The signal generator may be an all-pass filter. The all-pass filter, which consist of a cascade of amplifiers, controls the excitation signal, plus the reference signals. The reference signals are the electric test signal (Vₚ) and a 90° phase-shifted version (Vₙ) of the electric test signal generated by the signal generator. From the excitation signal (Vᵢₙ) the signal generator generates the electric test signal (Vₚ) for the piezoelectric transducers. The electric test signal (Vₚ) is also feed into to a first demodulator in the analysis circuit. The first demodulator is an in-phase lock-in chip. Further, the signal generator generates the 90° phase-shifted signal (Vₙ) of the electric test signal; this is feed into the second demodulator. The second demodulator is an out-of-phase component, an out-phase lock-in chip. The signal generator is designed such that the amplitude of the electric test signal (Vₚ) and the phase-shifted 90° signal (Vₙ) is constant in a frequency range from 30-400 kHz.

According to an embodiment, the dual-phase lock-in amplifier circuit comprises an in-phase lock-in chip and an out-phase lock-in chip, wherein the signal generator is arranged to apply the electric test signal (Vₚ) to the in-phase lock-in chip and to apply an 90° phase-shifted version (Vₙ) of the electric test signal to the out-phase lock-in chip.

The 90° phase-shifted signal (Vₙ) is used to detect intrinsic damage to the PZT patch itself, while the in-phase electric test signal (Vₚ) is more sensitive to the damage of the metal structure.

According to an embodiment, the analysis circuit comprises a trans-impedance amplifier (TIA), which is arranged to receive the electric return signal (I_{DUT}) from the piezoelectric transducer and to convert the electric return signal (I_{DUT}) to a voltage signal (V_{DUT}) for the in-phase lock-in chip and the out-phase lock-in chip.

The trans-impedance amplifier converts the current generated by the piezoelectric transducers to a voltage, this is feed into the demodulators, the in-phase lock-in chip and the out-phase lock-in chip.

The in-phase lock-in chip and the out-phase lock-in chip multiples the voltage signal with a reference signal to achieve a DC value, which is a voltage, and the same signal at twice the input signal.

According to an embodiment, the in-phase lock-in chip is arranged to multiply said voltage signal (V_{DUT}) with a reference signal to achieve a first DC value.

The reference signal for the in-phase lock-in chip is the electric test signal (Vₚ). The input, which is sinewaves, are transformed to a first DC value and an first AC value, by the in-phase lock-in chip, but only the DC value is used as it is easier to process. The AC value may be removed using a low pass filter.

According to an embodiment, the out-phase lock-in chip is arranged to multiply said voltage signal with a reference signal to achieve a second DC value.

The reference signal for the out-phase lock-in chip is the 90° phase-shifted signal (Vₙ). The input, which is sinewaves, are transformed to a second DC value by the out-phase lock-in chip.

According to an embodiment, the analysis circuit comprises a first low-pass filter, which is arranged to receive the first DC value and to generate an in-phase output value accordingly.

According to an embodiment, the analysis circuit comprises a second low-pass filter, which is arranged to receive the second DC value and to generate an out-of-phase output value accordingly.

The low-pass filters removes the value at twice the input signal, only the DC signal remains. This is done both for the in-phase and out-of-phase component. See FIG. 8 for further explanation.

According to an embodiment, the analysis circuit is arranged to forward the in-phase output value and the out-of-phase output value to the interface.

The interface samples the output value from the two demodulators, the in-phase lock-in chip and the out-phase lock-in chip.

According to an embodiment, the interface is arranged to store the in-phase output value and an out-of-phase output value.

The interface, which may be a signal processing unit, stores the in-phase output value and an out-of-phase output value for each measurement in an internal storage.

According to an embodiment, the interface is arranged to communicate the in-phase output value (Vₒᵤₜ₁) and an out-of-phase output value (Vₒᵤₜ₂) to an external device.

When an external device is contacting the interface, the interface communicates the stored values to the external devise. The stored in-phase output value and an out-of-phase output value for each measurement may be communicated through a USB port or through a wireless sensor network to an external device. The data may be communicated to the external device as a CVS file for easy data processing. The external device may be a laptop computer, a mobile phone or any other suitable devise for receiving data from the interface.

The external device is analysing the data. As mentioned-we are not interested in the exact accurate impedance value. First, the electro-mechanical impedance value (Ohmic value or voltage) is determined before any damage on the host structure; this is called the “healthy baseline”.

With equation 1, an impedance (Z_{PZT}) value can be calculated for the output from the demodulators (Vₒᵤₜ). The output from the demodulators (Vₒᵤₜ) may be in-phase output value (Vₒᵤₜ₁) or the out-of-phase output value (Vₒᵤₜ₂). The excitation signal Vᵢₙ and R_{f}, which is the feedback resistance of trans-impedance amplifier, are known and fixed. Therefore, the calculation is: (In reality, we should also include the gain of the lockin chip—but an approximated value is ok)

$${Z}_{PZT} = \frac{{R}_{f}}{{V}_{out}} {V}_{in} \qquad Equation 1$$

If damage happens, we will compare with the healthy baseline (which is saved). There are many damage model metrics in the literature that can be used to assess the amount of the damage. One is Root Mean Square deviation (RMSD), see equation 2. Where N is the total number of frequency components, measured at frequency n. Z_{n,h} and Z_{n,d} are the healthy impedance for the host structure and under damaged condition respectively. So, the larger RMSD the more damage. Alternatively, the shift of the resonant frequencies as a damage metric may be used.

$$RMSD = {\sum }_{n}^{N} \sqrt{\frac{{( {Z}_{n , d} - {Z}_{n , h} )}^{2}}{{Z}_{h}^{2}}} \qquad Equation 2$$

According to an embodiment, said electromechanical impedance representation represent a frequency range up to at least an upper frequency of 400 KHz.

At lower frequency, the waves can travel longer distances, and damage located at longer distances from the patch placement can be detected. With higher frequency, smaller damages may be detected, but at short distances. Around 400 KHz we start seeing the intrinsic behavior of the PZT patch, which we do not want. Below 30 kHz, the measurements are impacted by external noise (vibrations). Therefore, the frequency range typically is between 30 kHz and 400 KHz.

In a second aspect the invention further relates to a method for detecting corrosion or cracks in a metal structure embedded in concrete, the method comprising
at least one piezoelectric transducer arranged for contact with the metal structure,
an electronic circuit arranged for electric connection to the at least one piezoelectric transducer, the electronic circuit comprising a signal generator, an analysis circuit, and an interface arranged to communicate to an external device,

The method comprising the steps:
generating an electric test signal (Vₚ) to the at least one piezoelectric transducer, the electric test signal is generated by the signal generator,
receiving an electric return signal (I_{DUT}) from the at least one piezoelectric transducer in response to the electric test signal, the electric return signal (I_{DUT}) is received by the analysis circuit,
electrically transforming by the analysis circuit said electric return signal (I_{DUT}) from the piezoelectric transducer by means of a dual-phase lock-in amplifier circuit into a resulting electromechanical impedance representation of the metal structure,
communicating by an interface said electromechanical impedance representation to the external device.

The first and second aspect of the present invention may each be combined with any of the other aspects. These and other aspects of the invention will be apparent from and elucidated with reference to the embodiments described hereinafter.

### BRIEF DESCRIPTION OF THE FIGURES

The system and the method for detection corrosion and cracks according to the invention will now be described in more detail with regard to the accompanying figures. The figures show one way of implementing the present invention and is not to be construed as being limiting to other possible embodiments falling within the scope of the attached claim set.

FIG. 1. Illustrates the system for detecting corrosion or cracks in a metal structure embedded in concrete.

FIG. 2 illustrates the electronic circuit.

FIG. 3 shows a test sample made for testing the system and the method of the present invention.

FIG. 4 shows the measured electromechanical admittance measured by a commercial impedance analyser.

FIG. 5 the measured electromechanical admittance measured by a commercial impedance analyser.

FIG. 6 shows a comparison of measurements of the phase-information (real component) for the commercially available impedance analyser and the system of the present invention.

FIG. 7 shows a comparison of measurements of the phase-information (imaginary component) for the commercially available impedance analyser and the system of the present invention.

FIG. 8 shows the functionality of the demodulators.

### DETAILED DESCRIPTION OF AN EMBODIMENT

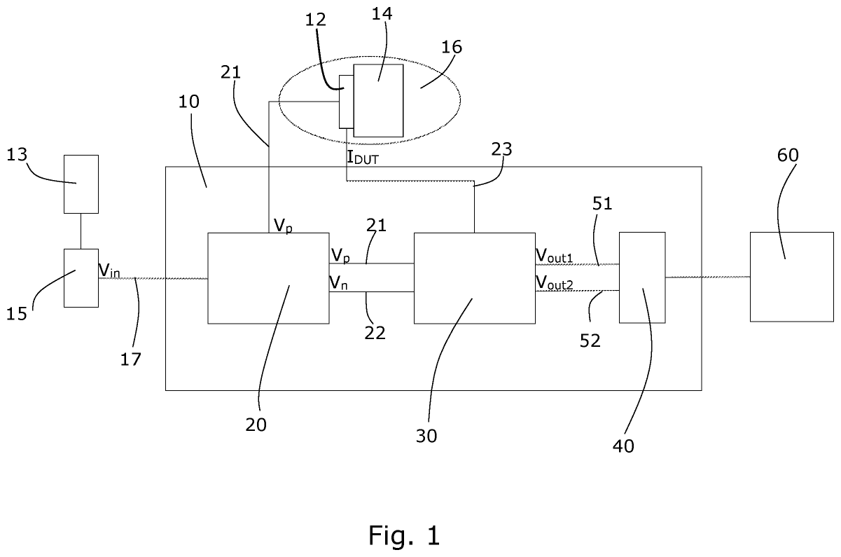

FIG. 1 illustrates the system for detecting corrosion or cracks in a metal structure embedded in concrete. The system comprises an electronic circuit 10. The electronic circuit 10 receives an excitation signal (Vᵢₙ) 17 from a frequency generator 15. A microcontroller 13 is controlling the frequency generator.

In the electronic circuit, the excitation signal (Vᵢₙ) 17 is received by a signal generator 20. The signal generator 20 generates an electric test signal (Vₚ) 21 for the piezoelectric transducers 12. Here only one piezoelectric transducers is shown, usually more than one are used for structures like bridges, tunnels, buildings etc. The piezoelectric transducers 12 are placed in contact with a reinforcement metal structure 14 embedded in concrete 16. The signal generator 20 also sends two reference signals to the analysis circuit. The reference signals are the electric test signal (Vₚ) 21 as well as a 90° phase-shifted version (Vₙ) 22 of the electric test signal generated by the signal generator.

The piezoelectric transducer 12 sends a signal into the metal structure 14, the signal is reflected and returned to the piezoelectric transducer, but the signal is changed after having passed through the metal structure. The piezoelectric transducers intercepts the reflected signal and returns the reflected signal as an electric return signal (I_{DUT}) 23 back to the electronic circuit 10. The electronic circuit comprises an analysis circuit 30, which receives the reference signals 21, 22 and the electric return signal (I_{DUT}) 23. The analysis circuit analyses the electric return signal (I_{DUT}) 23 and determines an electromechanically impedance representation or a voltage representation, which is communicated to the interface 40 as an in-phase output value (Vₒᵤₜ₁) 51 and an out-of-phase output value (Vₒᵤₜ₂) 52. The interface 40 stores the values and communicates it to an external device 60.

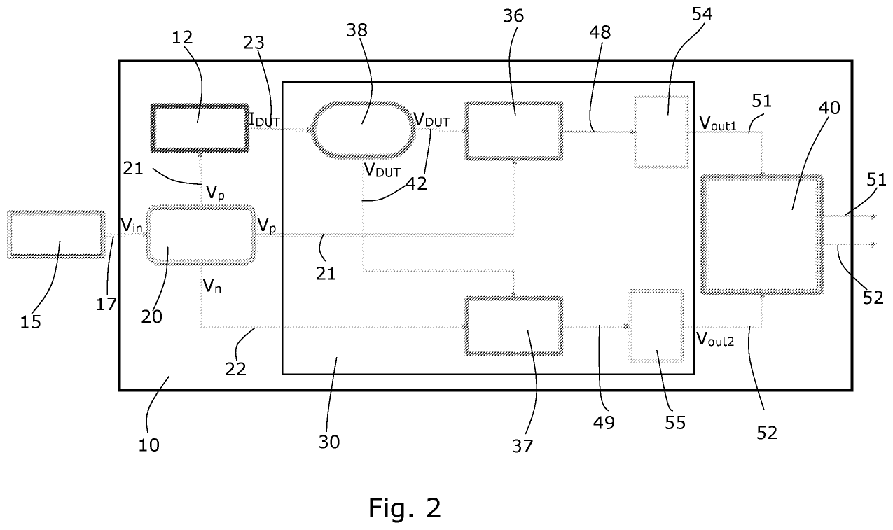

FIG. 2 illustrates the electronic circuit 10 with some more details. The electronic circuit 10 comprises a signal generator 20, which is an all-pass phase filter. The analysis circuit 30 comprises a trans-impedance amplifier (TIA) 38, two demodulators, which is the in-phase lock-in chip 36 and the out-phase lock-in chip 37, and two low pass filters, which is the first low-pass filter 54 and the second low-pass filter 55.

The signal generator 20 receives an excitation signal (Vᵢₙ) 17 from a frequency generator 15. The signal generator 20 generates an electric test signal (Vₚ) 21, which is sent to the piezoelectric transducers 12. The electric test signal (Vₚ) is also sent to the in-phase lock-in chip 36 as a reference signal, further an 90° phase-shifted signal (Vₙ) 22 of the electric test signal (Vₚ) 21 is sent to the out-phase lock-in chip 37 as a reference signal.

From the piezoelectric transducers 12 an electric return signal (I_{DUT}) 23, is sent to the trans-impedance amplifier (TIA) 38. The trans-impedance amplifier (TIA) 38 converts the electrical signal (I_{DUT}) 23 to a voltage signal (V_{DUT}) 42. The voltage signal (V_{DUT}) 42 is sent to the two demodulators, which is the in-phase lock-in chip 36 and the out-phase lock-in chip 37.

Based on the received electric test signal (Vₚ) 21 and the voltage signal (V_{DUT}) 42, the in-phase lock-in chip 36 generates a first DC value 48 and a first AC value which is sent to the first low pass filter 54, which removes the AC value to generate the in-phase output value (Vₒᵤₜ₁) 51 for the interface 40.

Further, based on the received 90° phase-shifted signal (Vₙ) 22 and the received voltage signal (V_{DUT}) 42 the out-phase lock-in chip 37 generates a second DC value 49 and a second AC value, which is sent to the second low pass filter 55. The second low pass filter 55 then removes the AC value and generates an out-of-phase output value (Vₒᵤₜ₂) 52 signal for the interface 40.

The interface 40 is a signal-processing unit, which stores the received values and, when activated by an external device 60, communicates the received values, preferable wireless, to the external device.

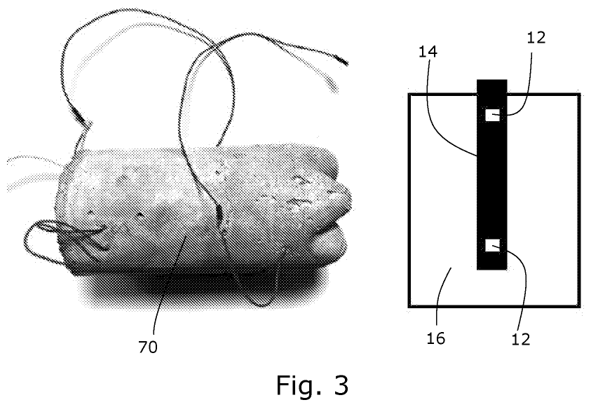

FIG. 3 shows a test sample made for testing the system and the method of the present invention. A reinforced concrete sample 70 was made, as seen to the left in FIG. 3, with reinforcement steel structure 14 and piezoelectric transducers 12 imbedded in the concrete with wires for connecting the piezoelectric transducers 12 to the electronic circuit sticking out from the concrete. The illustration to the right in FIG. 3 shows the elements in the test sample 70, with the piezoelectric transducers 12 attached to the reinforcement steel structure 14 embedded in the concrete 16.

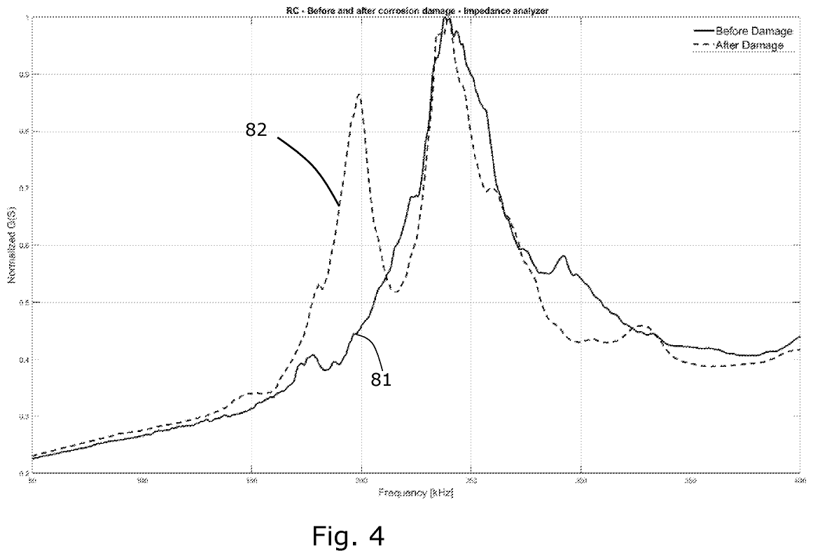

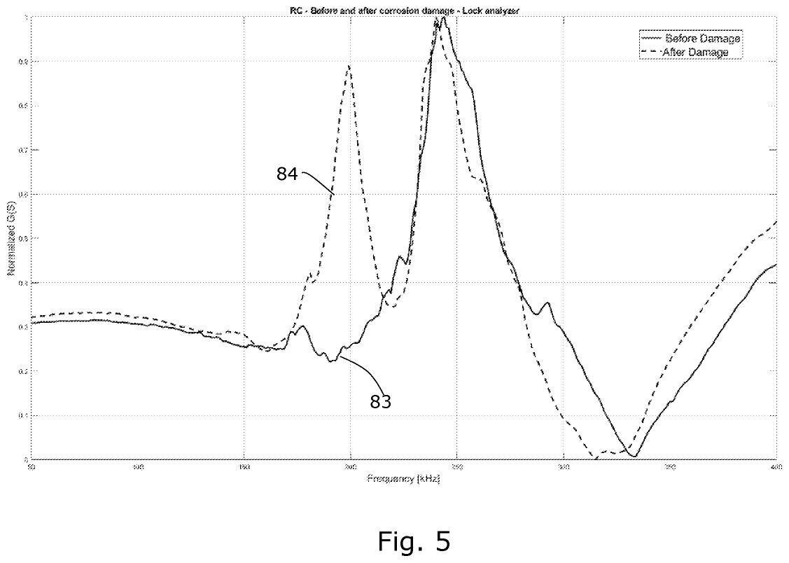

FIGS. 4 and 5 shows a comparison of the real part, the conductance, of the measured electromechanical admittance, which is the inverse of the impedance, measured by a commercial impedance analyser E4990A from Keysight and by the lock-in analyser according to the system and method of the present invention.

First, as shown in FIG. 4 measurements were performed to obtain the baseline electromechanical admittance signature for the commercial impedance analyser before the reinforced concrete sample was corroded, shown in the graph with reference 81, and after the reinforced concrete sample was corroded, shown in the graph with reference 82.

In FIG. 5, measurements were performed to obtain the baseline electromechanical admittance signature for the Lock-in analyser according to the system and method of the present invention. The graph with reference number 83 shows a measurement before the reinforced concrete sample was corroded, and the graph 84 shows a measurement after the reinforced concrete sample was corroded.

It is seen in FIGS. 4 and 5, how the signatures (admittance) change similarly both in the commercial available impedance analyser and in the Lock-in system and method of the present invention. This verifies the concept. There are some differences between the commercial available impedance analyser and the Lock-in approach signatures above 280 kHz, though this is not vital for the main principle.

Both FIGS. 4 and 5 shows a graph with one peak before the corrosion and two peaks after the corrosion. This shows that the low-cost Lock-in analyser, according to the system and method of the present invention, is able to detect corrosion as well as the expensive commercially available impedance analyser.

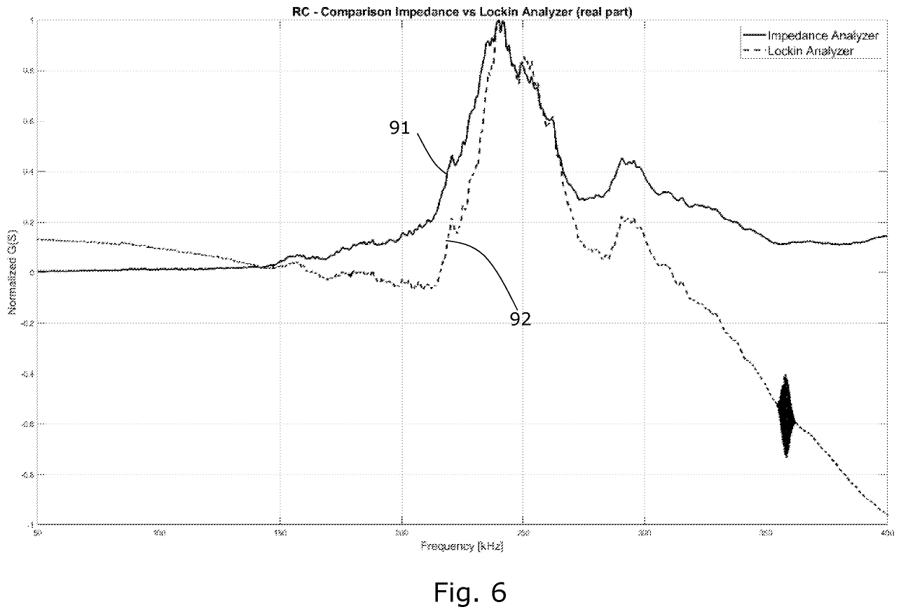

FIG. 6 shows measurements of the phase-information (real component) for the commercially available impedance analyser in the graph with reference number 91 and the Lock-in analyser according to the system and method of the present invention in the graph with reference number 92.

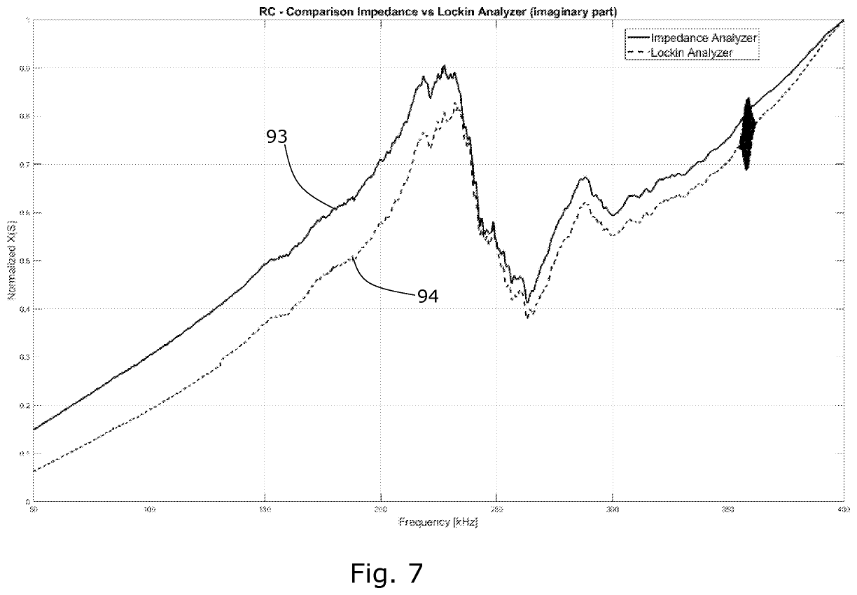

FIG. 7 shows measurements of the phase-information (imaginary component) for the commercially available impedance analyser in the graph with reference number 93 and the Lock-in analyser according to the system and method of the present invention in the graph with reference number 94.

FIGS. 6 and 7 shows that the method of the present invention is also able to give a good estimation of the phase-information, which is important, when assessing the integrity of the patch.

The out-of-phase (imaginary) component can be used for self-diagnostic for assessing the sensor patch integrity (such as disbonding). First, a baseline signature is recorded, which can later be compared with another recorded signature, to see damages.

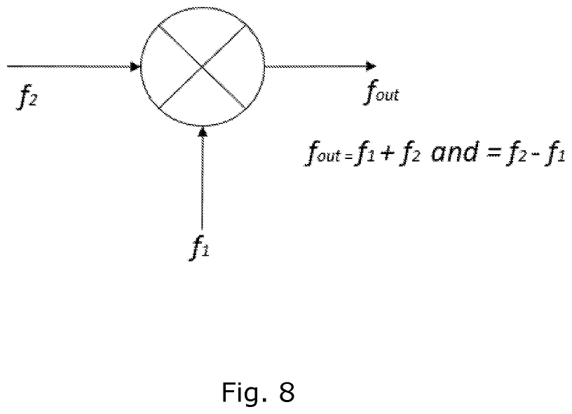

FIG. 8 shows the functionality of the demodulators, the phase lock-in chip 36 and the out-phase lock-in chip 37, below is explained the functionality of the in phase lock-in chip 36. The out-phase lock-in chip 37 works similar. For the in phase, lock-in chip 36 f₁ is the voltage signal (V_{DUT}) 42 from the trans-impedance amplifier 38 and contains the information from the PZT patch. f₂ is the electric test signal (Vₚ) 21, the in-phase signal from the signal generator 20; it has the same frequency as the voltage signal (V_{DUT}) but caries no information. The in-phase lock-in chip 36 multiplies these two signals: So mathematically, the product of the signal and reference can be separated into sum and difference components (see equation 3). Therefore, if the voltage signal (V_{DUT}) is 2 Hz, the electric test signal (V_{P}) is also 2 Hz (since it is the excitation signal). Then we have a component at 0 Hz (DC value) and one at 4 Hz (AC value). These two component carries the same information, but it much easier to work with a DC value—therefore the first low pass filter 54 removes the AC value.

$${V}_{p} ( t ) = {V}_{s} {V}_{R} cos [ ( {ω}_{s} + {ω}_{R} ) t + {φ}_{s} + {φ}_{R} ] + {V}_{s} {V}_{R} cos [ ( {ω}_{s} - {ω}_{R} ) t + {φ}_{s} - {φ}_{R} ] \qquad Equation 3$$

In equation 3 Vₚ (t) is the product Vₛ is the signal (the voltage signal (V_{DUT})) and V_{R} is the reference (the electric test signal (Vₚ)). ω is frequency in radians and φ is phase of the signals. Both for signal(s) (Vdut) and the reference signal (R))—in our case the electric test signal (Vp).

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A system for detecting corrosion or cracks in a metal structure embedded in concrete, the system comprising:
at least one piezoelectric transducer arranged for contact with the metal structure,
an electronic circuit arranged for electric connection to the at least one piezoelectric transducer, the electronic circuit comprising
a signal generator arranged to generate an electric test signal (Vₚ) to the at least one piezoelectric transducer,
an analysis circuit arranged to receive an electric return signal (I_{DUT}) from the at least one piezoelectric transducer in response to the electric test signal (Vₚ), and to electrically transform said electric return signal from the piezoelectric transducer by means of a dual-phase lock-in amplifier circuit into a resulting electromechanical impedance representation or voltage representation of the metal structure, and
an interface arranged to communicate said electromechanical impedance representation or voltage representation to an external device.

2. The system according to claim 1, wherein the signal generator is arranged to receive an excitation signal (Vᵢₙ) from a frequency generator.

3. The system according to claim 2, wherein the frequency generator is arranged to generate sine waves from 30-400 kHz for the excitation signal (Vᵢₙ).

4. The system according to any of the claim 2, wherein the signal generator is arranged to generate the electric test signal (Vₚ) to the at least one piezoelectric transducer by applying the excitation signal (Vᵢₙ) via an all-pass phase filter.

5. The system according to claim 4, wherein the dual-phase lock-in amplifier circuit comprises an in-phase lock-in chip and an out-phase lock-in chip, and wherein the signal generator is arranged to apply the electric test signal (Vₚ) to the in-phase lock-in chip and to apply an 90° phase-shifted version (Vₙ) of the electric test signal to the out-phase lock-in chip.

6. The system according to claim 5, wherein the analysis circuit comprises a trans-impedance amplifier (TIA) arranged to receive the electric return signal (I_{DUT}) from the piezoelectric transducer and to convert the electric return signal (I_{DUT}) to a voltage signal (V_{DUT}) for the in-phase lock-in chip and the out-phase lock-in chip.

7. The system according to claim 6, wherein the in-phase lock-in chip is arranged to multiply said voltage signal (V_{DUT}) with a reference signal (Vₚ) to achieve a first DC value.

8. The system according to claim 7, wherein the out-phase lock-in chip is arranged to multiply said voltage signal with a reference signal to achieve a second DC value.

9. The system according to claim 7, wherein the analysis circuit comprises a first low-pass filter, which is arranged to receive the first DC value and to generate an in-phase output value (Vₒᵤₜ₁) accordingly.

10. The system according to claim 8, wherein the analysis circuit comprises a second low-pass filter, which is arranged to receive the second DC value and to generate an out-of-phase output value (Vₒᵤₜ₂) accordingly.

11. The system according to claim 16, wherein the analysis circuit is arranged to forward the in-phase output value (Vₒᵤₜ₁) and the out-of-phase output value (Vₒᵤₜ₂) to the interface.

12. The system according to claim 11, wherein the interface is arranged to store the in-phase output value (Vₒᵤₜ₁) and an out-of-phase output value (Vₒᵤₜ₂).

13. The system according to claim 11, wherein the interface is arranged to communicate the in-phase output value (Vₒᵤₜ₁) and the out-of-phase output value (Vₒᵤₜ₂) to an external device.

14. The system according to claim 1, wherein said electromechanical impedance representation or voltage representation represents a frequency range up to at least an upper frequency of 400 KHz.

15. A method for detecting corrosion or cracks in a metal structure embedded in concrete, the method comprising:
with a system that comprises (i) at least one piezoelectric transducer arranged for contact with the metal structure, and (ii)
an electronic circuit arranged for electric connection to the at least one piezoelectric transducer, the electronic circuit comprising a signal generator, an analysis circuit, and an interface arranged to communicate to an external device,
generating an electric test signal (Vₚ) to the at least one piezoelectric transducer, the electric test signal (Vₚ) is generated by the signal generator,
receiving an electric return signal (I_{DUT}) from the at least one piezoelectric transducer in response to the electric test signal (Vₚ), the electric return signal (I_{DUT}) is received by the analysis circuit,
electrically transforming by the analysis circuit said electric return signal from the piezoelectric transducer by means of a dual-phase lock-in amplifier circuit into a resulting electromechanical impedance representation of the metal structure, and
communicating by an interface said electromechanical impedance representation or voltage representation to the external device.

16. The system according to claim 9, wherein the out-phase lock-in chip is arranged to multiply said voltage signal with a reference signal to achieve a second DC value, and wherein the analysis circuit comprises a second low-pass filter, the second low-pass filter being arranged to receive the second DC value and to generate an out-of-phase output value (Vₒᵤₜ₂) accordingly.

17. The system according to claim 12, wherein the interface is arranged to communicate the in-phase output value (Vₒᵤₜ₁) and the out-of-phase output value (Vₒᵤₜ₂) to an external device.

18. The system according to claim 16, wherein the interface is arranged to communicate the in-phase output value (Vₒᵤₜ₁) and the out-of-phase output value (Vₒᵤₜ₂) to an external device.
